(19) United States
(12) Patent Application Publication
(10) Pub. No.: US 2023/0370660 A1
(43) Pub. Date: Nov. 16, 2023

(54) CORRECTING FOR ERRORS IN VIDEO CONTENT RECEIVED BY AN ONLINE SYSTEM FROM A USER EXCHANGING VIDEO CONTENT WITH OTHER USERS

(71) Applicant: Meta Platforms, Inc., Menlo Park, CA (US)

(72) Inventor: Sammy El Ghazzal, Oberengstringen (CH)

(21) Appl. No.: 17/230,377

(22) Filed: Apr. 14, 2021

(51) Int. Cl. H04N 21/24; H04N 21/43; H04N 21/845; H04N 21/2743; G06K 9/00

(52) U.S. Cl. CPC H04N 21/2404; H04N 21/4307; H04N 21/8456; H04N 21/2743; G06K 9/00288; H04N 21/2402; G06K 9/00275

(57) ABSTRACT

When an online system creates a video exchange session where video content is presented to users participating in the video exchange session, the online system detects an error in video content received from a user, such as lag in the video content received from the user. In response to detecting the error in the video content from the user, the online system generates synthetic media from video content previously received from the user. The synthetic media synchronizes with audio included in the video content from the user and replaces at least a portion of the video content received from the user with the synthetic media. Other users participating in the video exchange receive the video content from the user replaced with the synthetic media to prevent the other users from noticing the error in the video content from the user.

### BACKGROUND

This disclosure relates generally to exchange of video content between users of an online system, and more specifically to the online system identifying and correcting errors in video content received from a user exchanging video content with other users.

Users of online systems increasingly communicate by exchanging video content captured by their respective client devices. For example, a user of an online system establishes a video exchange session with one or more other users of the online system. As another example, a user captures video content and provides the captured video content to an online system for distribution to and presentation to other users of the online system. This exchange of video content allows users of an online system to easily obtain video content about a range of topics or subjects. For example, users may exchange video content in real-time or in near-real time through a video exchange session established by the online system, allowing the users to interact with each other through the video exchange session.

Users exchanging video content through a video exchange session are affected by network conditions between their respective client devices and the online system. Varying network conditions, client device characteristics, or other characteristics may introduce errors into video content provided by a user to the online system, causing the online system to subsequently distribute the video content including errors to other users participating in a video exchange session with the user. For example, audio content received from the user may become unsynchronized with video content received by the user, causing other users in a video exchange session with the user to hear audio content from the user at a different time than video content corresponding to the audio content is displayed to the users. Such a lag between video content and audio content may impair understanding by users participating in a video exchange session video content from a user participating in a video exchange session with the user, which may decrease subsequent use of the online system for video exchange sessions by users.

### SUMMARY

An online system obtains video content from a user of the online system for exchange with one or more other users of the online system. For example, the online system receives video content captured by an image capture device of a client device of a user. In some embodiments, the online system obtains the video content during a video exchange session where users of the online system exchange video content. For example, the online system establishes a video exchange session between a requesting user and one or more users from whom acceptances of invitations to join the video exchange session were received. Hence, the online system may obtain the video content captured by an image capture device of a client device of a user participating in a video exchange session where video content is exchanged between various users of the online system. During a video exchange session, video content obtained by the online system from users participating in the video exchange session may be displayed to other users participating in the video exchange session in real-time or in near real-time from when the video content is obtained, allowing the users participating in the video exchange session to synchronously view and interact with video content from users participating in the video exchange session. The video content obtained by the online system includes a face of the user from whom the video content was obtained. For example, the obtained video content includes a face of the user captured by an image capture device included in a client device of the user.

Video content obtained from a user participating in the video exchange session may include one or more errors that affect display of the video content to other users participating in the video exchange session. For example, audio content obtained in conjunction with the video content is desynchronized from video content corresponding to times when the audio content was obtained. Hence, users participating in the video exchange session may hear the audio content before video content corresponding to times when the user generated the audio content is displayed, or vice versa, creating a lag between audio content and video content corresponding to the video content. As another example, audio content obtained in conjunction with video content is audibly presented during the video exchange session while a limited number of frames of video data obtained in conjunction with the audio content are displayed to other users, causing a user from whom the audio content was obtained to appear frozen or static for durations of the video content displayed to users participating in the video exchange session while the audio content obtained from the user is presented to users participating in the video exchange session.

To compensate for such errors in video content obtained from a user participating in the video exchange session, the online system detects an error in the video content obtained from the user. In some embodiments, the online system receives information describing a connection between a client device of the user and a network in conjunction with the video content. Example information describing the connection between the client device of the user and the network includes a connection strength, a connection speed, a connection type, or any other suitable information. The online system detects the error in the video content in response to the information describing the connection between the client device of the user and the network satisfying one or more conditions. As another example, the client device compares an amount of data transmitted to the online system when transmitting video content to an amount of data the online system indicated as received by the online system and detects the error in the video content in response to the amount of data indicated as received by the online system being less than the amount of data transmitted to the online system when transmitting video content by at least a threshold amount.

In some embodiments, the online system detects the error in the video content by comparing the obtained video content from the user with corresponding audio content obtained from the user. For example, the online system determines predicted positions of one or more portions of the face of the user included in the obtained video content corresponding to various portions of the audio content obtained in conjunction with the video content. The online system compares the predicted positions of the one or more portions of the face of the user to the positions of the portions of the face of the user in the obtained video content. In response to at least a threshold difference between a predicted position of a portion of the face of the user to the position of the portion of the face of the user, the online system detects the error in the video content. The online system maintains a model that generates positions of portions of the user's face when different sounds, such as phonemes, are spoken by the user in some embodiments. For example, the online system trains the model from captured video including the user's face, or faces of other users, when different sounds are spoken by the user, or by the other users. The online system applies the trained model to audio content obtained from a client device of the user to generate an image or video including predicted positions of portions of the user's face when the audio content is spoken. For example, the online system determines a predicted position of the user's lips based on audio content at a specific timestamp of the audio content and compares the predicted position of the user's lips to a position of the user's lips at a timestamp of the video content corresponding to the specific timestamp of the audio content. In response to the predicted position of the user's lips at the specific timestamp of the audio content differing from a position of the user's lips in the video content at the timestamp of the video content corresponding to the specific timestamp of the audio content, the online system detects an error in the video content.

Responsive to detecting the error in the video content obtained from the user, the online system generates synthetic media that synchronizes with audio content obtained in conjunction with the video content. The synthetic media is artificial video content generated by the online system from previously obtained video content and the audio content obtained in conjunction with the video content. In some embodiments, the online system identifies components of the audio content, such as different phonemes in the audio content, and applies the trained model to generate predicted positions of one or more portions of the user's face corresponding to each phoneme. From the predicted positions of the one or more portions of the user's face and previously obtained video content, the online system generates synthetic media displaying the predicted positions of the one or more portions of the user's face when the audio content is played. In various embodiments, the online system maintains a media generation model that receives input as the predicted positions of the one or more portions of the user's face and an identifier of the user, which may include a frame of the obtained video content including the face of the user. For example, the frame of the obtained video content is a frame of the video content obtained by the online system 140 before the error was detected. From the predicted positions of the one or more portions of the user's face and the identifier of the user, the media generation model determines one or more of a pose, an expression, and an eye gaze of the user's face and generates synthetic media comprising frames of artificial video including a representation of the user's face having the determined pose, expression, or eye gaze. As the predicted positions of the one or more user's face correspond to different portions of the audio content, the artificial video is a representation of the user's face when the user is saying a portion of the audio content. Further, the media generation model may receive as input obtained video from other users participating in the video exchange session with the user and account for information about faces of the other users (e.g., poses or expressions of the other users participating in the video exchange session), allowing the media generation model to account for contextual information about other users participating in the video exchange when generating the frames or artificial video including the face of the user.

Using the generated synthetic media and the video content obtained from the user, the online system generates modified video content for the user by replacing at least a portion of the video content obtained from the user with the synthetic media. The modified video data replaces one or more portions of the video content obtained from the user with corresponding portions from the synthetic media. For example, the online system generates the modified video content by detecting one or more features of the user's face within frames of the obtained video content and replaces the detected one or more features of the user's face with corresponding representations of the detected one or more features from the generated synthetic media. As an example, the online system detects the user's lips in the obtained video content through any suitable facial recognition or facial detection method and replaces portions of one or more frames of the video content where the user's lips were detected with a representation of the user's lips from the synthetic media. In various embodiments, the online system determines a duration of the detected error and replaces a greater amount of content within frames of the obtained video content with content from the synthetic media as the duration of the detected error increases. Hence, the online system 140 adjusts an amount of content within frames of the obtained video content replaced by corresponding content from the synthetic media based on an extent of the detected error in the video content obtained from the user.

The online system transmits the modified video content along with the audio content obtained in conjunction with the video content to client devices of one or more other users of the online system participating in the video exchange session for display. As the synthetic media is generated to synchronize with the audio content, the modified video content compensates for the detected error in the video content obtained from the user by synchronizing the representations of one or more portions of the user's face from the synthetic media with the audio content obtained in conjunction with the video content. This allows the online system to provide users participating in the video exchange with the user with video content that is synchronized with audio content that was obtained along with the video content. When the obtained video content does not include an error, the online system does not modify the obtained video content to include portions from synthetic media generated by the online system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIGS. 3A and 3B are example interfaces displayed to users who have joined a video exchange session, in accordance with an embodiment.

FIG. 4 is a flowchart of a method for identifying and correcting errors included in video content received by an online system and presented to users during a video exchange session, in accordance with an embodiment.

FIG. 5 is a process flow diagram of a method for identifying and correcting errors included in video content received by an online system and presented to users during a video exchange session, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

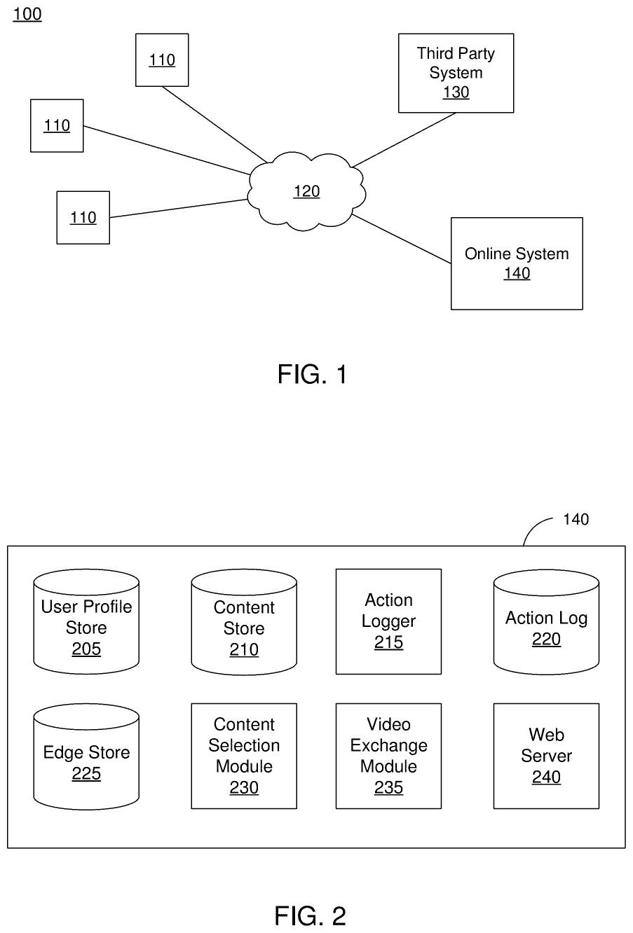

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a content selection module 230, a video exchange module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with content items when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

The video exchange module 235 allows users of the online system 140 to exchange video content captured by client devices 110 corresponding to each of the users. In various embodiments, the video exchange module 235 receives a creation request from a requesting user for a video exchange session to exchange video content with other users that identifies one or more other users. The video exchange module 235 transmits an invitation to join a video exchange session to the identified one or more other users. The invitation includes information identifying the video exchange session, and a link that, when accessed by a user via a client device 110, causes the client device 110 of the user to join the video exchange session. For example, the requesting user specifies a name of the video exchange session in the creation request to the video exchange module 235, and the invitation transmitted from the video exchange module 235 to one or more other users identified by the creation request includes the name of the video exchange session. The invitation transmitted from the video exchange module 235 to the one or more other users may include other information, such as a description of the video exchange session or information identifying the requesting user.

When the requesting user and at least one other user join the video exchange session, the video exchange module 235 generates an interface that is displayed to the requesting user and to other users who have joined the video exchange session. In various embodiments, the video exchange module 235 partitions the interface into regions, with each region corresponding to a user who has joined the video exchange session. The video exchange module 235 receives video content from a client device 110 of a user who has joined the video exchange session and displays the received video in a region of the interface corresponding to the user who has joined the video exchange session. The interface is transmitted to client devices 110 of users who have joined the video exchange session. Hence, the interface transmitted to a client device 110 of a user who has joined the video exchange session includes regions displaying video content from client devices 110 of other users who have joined the video exchange session, allowing for synchronous, or near-synchronous, exchange of video content between the users who have joined the video exchange session. In some embodiments, the interface includes a region showing video content from a user 110 who is viewing the interface, allowing the user to see the video from the user via the interface along with video content from other users who have joined the video exchange session. Alternatively, the interface does not include a region showing video content from the user who is viewing the interface, so the interface does not display video from the user who is viewing the interface, instead showing video content from other users who have joined the video exchange session to the user, with the user unable to view video content provided by the user to the video exchange module 235 via the interface shown to the user. In various embodiments,

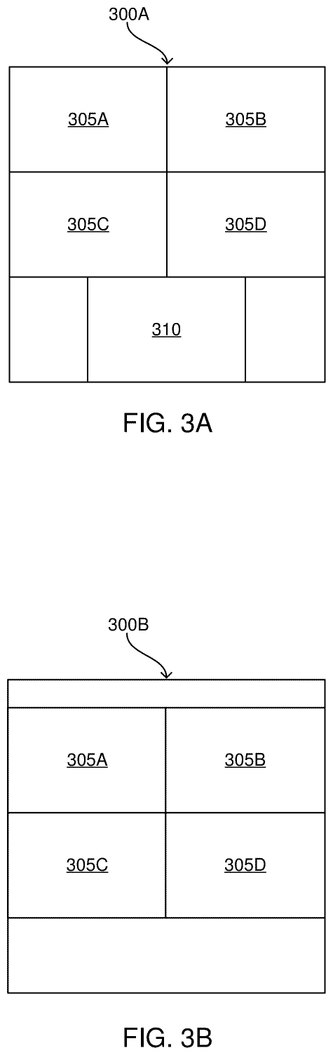

FIGS. 3A and 3B show example interfaces generated by the video exchange module 235 and displayed to users who have joined a video exchange session. For purposes of illustration, FIGS. 3A and 3B show interfaces presented to a viewing user via a client device 110 of the viewing user. In the example shown by FIG. 3A, interface 300A includes regions 305A, 305B, 305C, 305D that each correspond to other users who have joined the video exchange session. Region 305A displays video content that the video exchange module 235 receives from a client device 110 of a first user, while region 305B displays video content that the video exchange module 235 receives from a client device 110 of a second user. Similarly, region 305C displays video content the video exchange module 235 receives from a client device 110 of a third user, and region 305D displays video content the video exchange module 235 receives from a client device 110 of a fourth user. Interface 300A also includes local region 310 that displays video content captured by the client device 110 of the viewing user and transmitted to the video exchange module 235, allowing the viewing user to view the video content that the client device 110 of the viewing user is transmitting to the video exchange module 235 via interface 300A.

In contrast, FIG. 3B shows interface 300B, which includes regions 305A, 305B, 305C, 305D but does not include local region 310. Hence, interface 300B allows the viewing user to view video content that the video exchange module 235 receives from other users corresponding to regions 305A, 305B, 305C, 305D, but does not display video content captured by the client device 110 of the viewing user and transmitted to the video exchange module 235. In some embodiments, the viewing user may alter inclusion of local region 310 in interface 300A by modifying a setting maintained by the online system 140 for the user or maintained by an application executing on the client device 110 of the viewing user that displays interface 300A; hence, the viewing user may select display of interface 300A or interface 300B via the viewing user's client device 110 through one or more settings maintained for the viewing user by an application on the viewing user's client device 110 of by the online system 140.

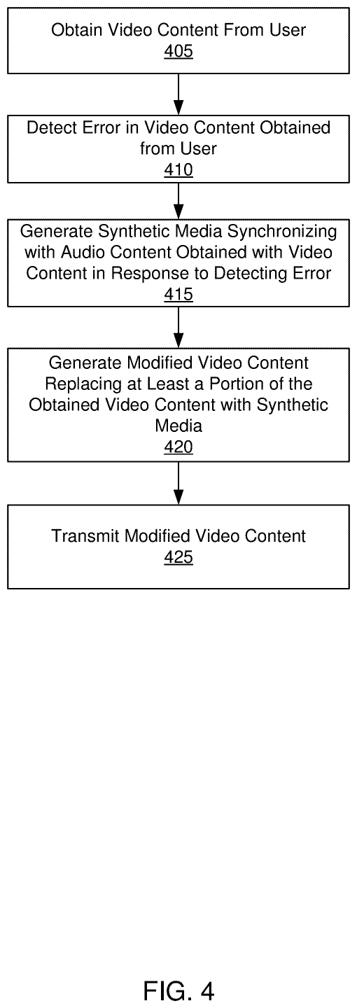

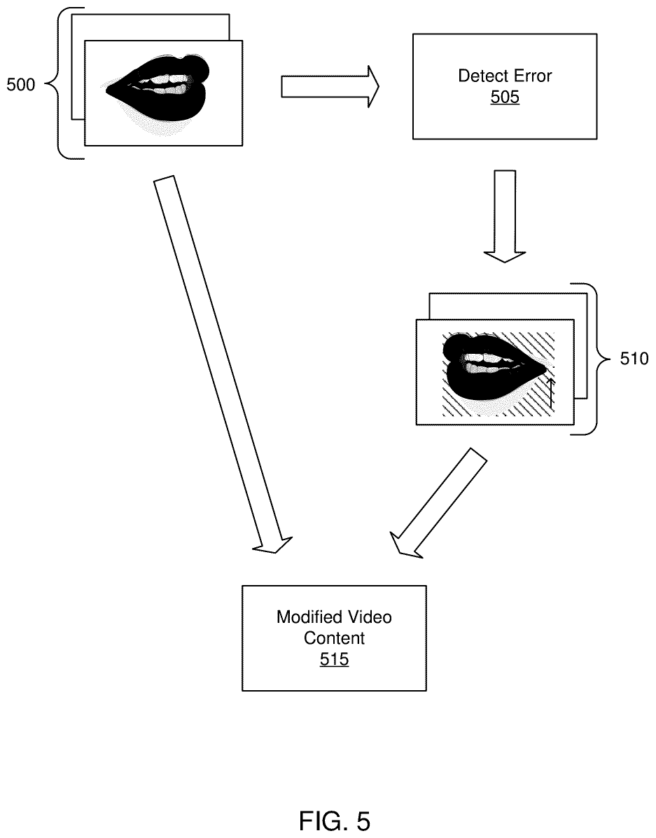

Additionally, the video exchange module 235 may detect errors in video content obtained from a user of the online system 140 that includes a face of the user for display to other users via a video exchange session. For example, the video exchange module 235 detects an error when audio content obtained in conjunction with the video content is not synchronized with the video content (e.g., the video content lags behind the audio content), as further described below in conjunction with FIGS. 4 and 5. To compensate for a detected error, the video exchange module 235 generates synthetic video from audio content received in conjunction with the video content. As further described below in conjunction with FIGS. 4 and 5, the video exchange module 235 applies one or more trained models to the audio content and to previously obtained video content to generate representations of the user's face when speaking various portions of the audio content; hence, the synthetic media includes generated representations of the user's face corresponding to speaking different portions of the audio content. For frames of the video content where the video exchange module 235 detected an error, the video exchange module replaces one or more portions of the user's face in the frames where an error was detected with corresponding portions of the representation of the user's face from corresponding frames of the synthetic media. Hence, the video exchange module 235 generates modified video content by combining portions of the user's face from the video content with portions of the representation of the user's face from the synthetic media. As further described below in conjunction with FIGS. 4 and 5, the representation of the user's face in the synthetic media is synchronized with the audio content obtained with the video content, so the modified video content is synchronized with the audio content. The video exchange module 235 transmits the modified video content to the users participating in the video exchange session, removing errors from desynchronization of audio content and video content obtained from the user in the content displayed to users in the video exchange session.

Referring back to FIG. 2, the web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

### Error Compensation in Video Received by a User and Presented in a Video Exchange Session

FIG. 4 is a flowchart of one embodiment of a method for identifying and correcting errors included in video content received by an online system 140 and presented to users during a video exchange session. In various embodiments, the method includes different or additional steps than those described in conjunction with FIG. 4. Further, in some embodiments, the steps of the method are performed in different orders than the order described in conjunction with FIG. 4.

An online system 140 obtains 405 video content from a user of the online system 140 for exchange with one or more other users of the online system 140. For example, the online system 140 receives video content captured by an image capture device of a client device 110 of a user. In some embodiments, the online system 140 obtains 405 the video content during a video exchange session where users of the online system 140 exchange video content. For example, the online system 140 establishes a video exchange session between a requesting user and one or more users from whom acceptances of invitations to join the video exchange session were received. Hence, the online system 140 may obtain 405 the video content captured by an image capture device of a client device 110 of a user participating in a video exchange session where video content is exchanged between various users of the online system 140. During a video exchange session, video content obtained 405 by the online system 140 from users participating in the video exchange session may be displayed to other users participating in the video exchange session in real-time or in near real-time from when the video content is obtained 405, allowing the users participating in the video exchange session to synchronously view and interact with video content from users participating in the video exchange session. The video content obtained 405 by the online system 140 includes a face of the user from whom the video content was obtained 405. For example, the obtained video content includes a face of the user captured by an image capture device included in a client device 110 of the user.

Video content obtained 405 from a user participating in the video exchange session may include one or more errors that affect display of the video content to other users participating in the video exchange session. For example, audio content obtained in conjunction with the video content is desynchronized from video content corresponding to times when the audio content was obtained. Hence, users participating in the video exchange session may hear the audio content before video content corresponding to times when the user generated the audio content is displayed, or vice versa, creating a lag between audio content and video content corresponding to the video content. As another example, audio content obtained in conjunction with video content is audibly presented during the video exchange session while a limited number of frames of video data obtained 405 in conjunction with the audio content are displayed to other users, causing a user from whom the audio content was obtained to appear frozen or static for durations of the video content displayed to users participating in the video exchange session while the audio content obtained from the user is presented to users participating in the video exchange session.

To compensate for such errors in video content obtained 405 from a user participating in the video exchange session, the online system 140 detects 410 an error in the video content obtained from the user. In some embodiments, the online system 140 receives information describing a connection between a client device 110 of the user and a network 120 in conjunction with the video content. Example information describing the connection between the client device 110 of the user and the network 120 includes a connection strength, a connection speed, a connection type, or any other suitable information. The online system 140 detects 410 the error in the video content in response to the information describing the connection between the client device 110 of the user and the network 120 satisfying one or more conditions. For example, the online system 140 detects 410 the error in the video content in response to a connection strength of the connection between the client device 110 of the user and the network 120 being less than a threshold strength or in response to a connection speed of the connection between the client device 110 of the user and the network 120 being less than a threshold speed. As another example, in response to the type of connection being a specific type, the online system 140 detects 410 an error in the video content. Alternatively, the client device 110 from which the online system 140 obtains 405 the video content locally detects 410 the error in the video content and transmits a flag indicating detection of an error in conjunction with the video content. The client device 110 detects 410 the error in the video content based on the connection between the client device 110 and the network 120, as further described above, in various embodiments. As another example, the client device 110 compares an amount of data transmitted to the online system 140 when transmitting video content to an amount of data the online system 140 indicated as received by the online system 140 and detects 410 the error in the video content in response to the amount of data indicated as received by the online system 140 being less than the amount of data transmitted to the online system 140 when transmitting video content by at least a threshold amount.

Additionally or alternatively, the online system 140 maintains information describing characteristics of networks 140 used by client devices 110 to exchange data with the online system 140. For example, the online system 140 stores information describing historical connection strength or connection rates in conjunction with network identifiers for different networks 140. The online system 140 receives a network identifier of a network 140 used by the client device 110 of the user when the online system 140 obtains 405 the video content and retrieves stored historical information describing characteristics of the network 120. In response to the historical information describing one or more characteristics of the network 120 satisfying one or more criteria, as further described above, the online system 140 detects 410 an error in the obtained video content,

In some embodiments, the online system 140 detects 410 the error in the video content by comparing the obtained video content from the user with corresponding audio content obtained from the user. For example, the online system 140 determines predicted positions of one or more portions of the face of the user included in the obtained video content corresponding to various portions of the audio content obtained in conjunction with the video content. The online system 140 compares the predicted positions of the one or more portions of the face of the user to the positions of the portions of the face of the user in the obtained video content. For example, the online system 140 selects a timestamp of the audio content, determines a predicted position of a portion of a face of the user at the selected timestamp of the audio content, and compares the predicted position of the portion of the face of the user at the selected timestamp of the audio content to the position of the portion of the face of the user in the video content at a timestamp corresponding to the selected timestamp of the audio content. In response to at least a threshold difference between a predicted position of a portion of the face of the user to the position of the portion of the face of the user, the online system 140 detects 410 the error in the video content. The online system 140 maintains a model that generates positions of portions of the user's face when different sounds, such as phonemes, are spoken by the user in some embodiments. For example, the online system 140 trains the model from captured video including the user's face, or faces of other users, when different sounds are spoken by the user, or by the other users. The online system 140 labels features of the image or video identifying different portions of the user's face with a label identifying a sound spoken by the user corresponding to the image or video and trains the model using any suitable method (e.g., supervised, semi-supervised, etc.). The online system 140 applies the trained model to audio content obtained from a client device 110 of the user to generate an image or video including predicted positions of portions of the user's face when the audio content is spoken. For example, the online system 140 determines a predicted position of the user's lips based on audio content at a specific timestamp of the audio content and compares the predicted position of the user's lips to a position of the user's lips at a timestamp of the video content corresponding to the specific timestamp of the audio content. In response to the predicted position of the user's lips at the specific timestamp of the audio content differing from a position of the user's lips in the video content at the timestamp of the video content corresponding to the specific timestamp of the audio content, the online system 140 detects 410 an error in the video content.

Responsive to detecting 410 the error in the video content obtained 405 from the user, the online system 140 generates 415 synthetic media that synchronizes with audio content obtained in conjunction with the video content. The synthetic media is artificial video content generated by the online system 140 from previously obtained 405 video content and the audio content obtained in conjunction with the video content. In some embodiments, the online system 140 identifies components of the audio content, such as different phonemes in the audio content, and applies the trained model, further described above, to generate predicted positions of one or more portions of the user's face corresponding to each phoneme. From the predicted positions of the one or more portions of the user's face and previously obtained 405 video content, the online system 140 generates synthetic media displaying the predicted positions of the one or more portions of the user's face when the audio content is played. In various embodiments, the online system 140 maintains a media generation model that receives input as the predicted positions of the one or more portions of the user's face and an identifier of the user, which may include a frame of the obtained video content including the face of the user. For example, the frame of the obtained video content is a frame of the video content obtained 405 by the online system 140 before the error was detected. From the predicted positions of the one or more portions of the user's face and the identifier of the user, the media generation model determines one or more of a pose, an expression, and an eye gaze of the user's face and generates synthetic media comprising frames of artificial video including a representation of the user's face having the determined pose, expression, or eye gaze. As the predicted positions of the one or more user's face correspond to different portions of the audio content, the artificial video is a representation of the user's face when the user is saying a portion of the audio content. In various embodiments, the media generation model is trained using previously obtained 405 video content including the user, so the online system 140 stores a media generation model in association with each user to generate artificial video for the associated user. Further, the media generation model may receive as input obtained video from other users participating in the video exchange session with the user and account for information about faces of the other users (e.g., poses or expressions of the other users participating in the video exchange session), allowing the media generation model to account for contextual information about other users participating in the video exchange when generating the frames or artificial video including the face of the user.

Using the generated synthetic media and the video content obtained 405 from the user, the online system 140 generates 420 modified video content for the user by replacing at least a portion of the video content obtained 405 from the user with the synthetic media. The modified video data replaces one or more portions of the video content obtained 405 from the user with corresponding portions from the synthetic media. For example, for one or more frames of the obtained 405 video data corresponding to a detected 410 error, the online system 140 generates 420 modified video content by replacing the user's face included in the obtained video content with the representation of the user's face from the generated synthetic media. Alternatively, the online system 140 generates 420 the modified video content by detecting one or more features of the user's face within frames of the obtained video content and replaces the detected one or more features of the user's face with corresponding representations of the detected one or more features from the generated synthetic media. For example, the online system 140 detects the user's lips in the obtained video content through any suitable facial recognition or facial detection method and replaces portions of one or more frames of the video content where the user's lips were detected with a representation of the user's lips from the synthetic media. In various embodiments, the online system 140 determines an amount of content within frames of the obtained video content to replace with corresponding content from the synthetic media based on the detected 410 error in the obtained video content. For example, the online system 140 determines a duration of the detected error and replaces a greater amount of content within frames of the obtained video content with content from the synthetic media as the duration of the detected error increases. As an example, when the detected error has less than a threshold duration, the online system 140 generates 420 the modified video content by replacing one or more specific portions of the user's face within the obtained video content (e.g., the user's lips) with corresponding specific portions of the representation of the user's face from the synthetic media; when the duration of the detected error equals or exceeds the threshold duration, the online system 140 generates 420 the modified video content by replacing the user's face within the obtained video content with the representation of the user's face from the synthetic media. Hence, the online system 140 adjusts an amount of content within frames of the obtained video content replaced by corresponding content from the synthetic media based on an extent of the detected error in the video content obtained 405 from the user.

The online system 140 transmits 425 the modified video content along with the audio content obtained in conjunction with the video content to client devices 110 of one or more other users of the online system 140 participating in the video exchange session for display. As the synthetic media is generated 415 to synchronize with the audio content, the modified video content compensates for the detected error in the video content obtained 405 from the user by synchronizing the representations of one or more portions of the user's face from the synthetic media with the audio content obtained in conjunction with the video content. This allows the online system 140 to provide users participating in the video exchange with the user with video content that is synchronized with audio content that was obtained along with the video content. When the online system 140 determines the obtained video content no longer includes an error or does not include an error, the online system 140 transmits the obtained video content to the client devices 110 of the other users rather than transmit the modified video content. Hence, when the obtained video content does not include an error, the online system 140 does not modify the obtained video content to include portions from synthetic media generated 420 by the online system 140.

FIG. 5 is a process flow diagram of method for identifying and correcting errors included in video content received by an online system 140 and presented to users during a video exchange session. In the example of FIG. 5, the online system 140 obtains video content 500 from a client device 110 of a user participating in a video exchange session with other users of the online system 140. The video content 500 includes a face of a user. During the video exchange session, the online system 140 transmits the video content 500 from the client device 110 of the user to client devices 110 of other users participating in the video exchange session, which display the video content 500 to the other users.

When the online system 140 receives the video content 500 from the client device 110, the online system 140 determines whether the video content 500 includes one or more errors. As described above in conjunction with FIG. 4, the online system 140 determines the video content 500 includes an error when audio content obtained in conjunction with the video content 500 does not synchronize with the video content 500. Hence, the online system 140 detects 505 an error in the video content 500 when a time when a portion of audio content obtained in conjunction with the video content 500 is obtained at a different time than a time when a portion of the video content 500 corresponding to the audio content is obtained. As further described above in conjunction with FIG. 4, the online system 140 may alternatively or additionally use characteristics of a connection by the client device 110 from which the video content 500 was obtained to a network 120 for communicating with the online system 140 to detect 505 the error in the video content.

In response to detecting 505 the error in the video content, the online system 140 generates synthetic media 510 that includes one or more frames including a representation of a face of the user included in the video content 500. In some embodiments, the online system 140 identifies components of audio content obtained along with the video content 500, such as different phonemes in the audio content, and applies a trained model, further described above in conjunction with FIG. 4, to generate predicted positions of one or more portions of the user's face corresponding to each phoneme. From the predicted positions of the one or more portions of the user's face and the video content 500, the online system 140 generates the synthetic media 510 that displays predicted positions of the one or more portions of the user's face when the audio content is played. In various embodiments, the online system 140 applies a media generation model to predicted positions of the one or more portions of the user's face and an identifier of the user, which may include a frame of the obtained video content including the face of the user. For example, the frame of the obtained video content is a frame of the video content obtained 405 by the online system 140 before the error was detected 505. From the predicted positions of the one or more portions of the user's face and the identifier of the user, the media generation model generates the synthetic media 510 that includes one or more of a pose, an expression, and an eye gaze of the user's face.

From the generated synthetic media 510 and the obtained video content 500, the online system 140 generates modified video content 515 for the user by replacing at least a portion of the video content 500 with the synthetic media 510. Hence, the modified video content 515 includes portions of the video content 500 and portions of the synthetic media 510. For example, the online system 140 replaces one or more portions of the video content 500 from the user with corresponding portions from the synthetic media 510. As an example, for one or more frames of the video content 500 corresponding to a detected 505 error, the modified video data 515 replaces one or more portions of the user's face included in the video content 500 with corresponding portions of a representation of the user's face from the generated synthetic media 510. Hence, the modified video content 515 replaces one or more features of a user's face subject to the detected 505 error with corresponding features from the representation of the user's face from the generated synthetic media 510. As the synthetic media 510 is synchronized with audio content obtained in conjunction with the video content 510, the modified video content 515 compensates for the detected 505 error in the video content 500 by synchronizing the representations of one or more portions of the user's face from the synthetic media 510 with the audio content obtained in conjunction with the video content 500.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
obtaining video content at an online system from a client device of a user of the online system for exchange with one or more other users of the online system, the video content including one or more portions of a face of the user;
detecting an error in the video content obtained from the user where audio content obtained in conjunction with the video content is desynchronized from the video content, wherein detecting the error comprises comparing the video content obtained from the user with the audio content obtained from the user;
responsive to detecting the error in the video content obtained from the user, generating, by the online system, synthetic media that synchronizes with the audio content obtained in conjunction with the video content obtained from the user;
generating, by the online system, modified video content obtained from the user by replacing at least a portion of the video content obtained from the user that includes one or more portions of the face of the user with the synthetic media; and
transmitting the modified video content from the online system to client devices of the one or more other users of the online system for display.

2. The method of claim 1, wherein detecting the error in the video content obtained from the user further comprises:
receiving information describing a connection between the client device of the user and the online system from the client device; and
responsive to the information describing the connection between the client device of the user and the online system satisfying one or more conditions, detecting the error in the video content obtained from the user.

3. The method of claim 2, wherein the information describing the connection between the client device and the online system includes a connection strength.

4. The method of claim 3, wherein responsive to the information describing the connection between the client device of the user and the online system satisfying one or more conditions, detecting the error in the video content obtained from the user comprises:
responsive to the connection strength being less than a threshold strength, detecting the error in the video content obtained from the user.

5. The method of claim 2, wherein the information describing the connection between the client device and the online system includes a connection speed.

6. The method of claim 3, wherein responsive to the information describing the connection between the client device of the user and the online system satisfying one or more conditions, detecting the error in the video content obtained from the user comprises:
responsive to the connection speed being less than a threshold speed, detecting the error in the video content obtained from the user.

7. The method of claim 1, wherein detecting the error in the video content obtained from the user comprises:
receiving information identifying a network coupling the client device of the user and the online system;
retrieving information stored by the online system describing one or more historical characteristics of the network;
responsive to the retrieved information describing the one or more historical characteristics of the network satisfying one or more conditions, detecting the error in the video content obtained from the user.

8. The method of claim 1, wherein detecting the error in the video content obtained from the user comprises:
comparing, by the online system, positions of one or more portions of the face of the user in the obtained video content with predicted positions of the one or more portions of the face of the user determined by the online system from audio content obtained in conjunction with the video content; and
in response to at least a threshold difference between the positions of one or more portions of the face of the user in the obtained video content and the predicted positions of the one or more portions of the face of the user determined by the online system from audio content obtained in conjunction with the video content, detecting the error in the video content.

9. The method of claim 8, wherein comparing, by the online system, the positions of one or more portions of the face of the user in the obtained video content with the predicted positions of the one or more portions of the face of the user determined by the online system from audio content obtained in conjunction with the video content comprises:
selecting, by the online system, a timestamp of the audio content;
generating a predicted position of the one or more portions of the face of the user at the timestamp by applying a trained model that generates positions of portions of the face of the user when different sounds are spoken to the audio content corresponding to the timestamp; and
comparing the predicted position of the one or more portions of the face of the user to positions of the face of the user at a timestamp of the obtained video content corresponding to the timestamp.

10. The method of claim 1, wherein generating, by the online system, synthetic media that synchronizes with audio content obtained in conjunction with the video content obtained from the user comprises:
applying a trained media generation model maintained by the online system to an identifier of the user and predicted positions of one or more portions of the face of the user corresponding to one or more times of the audio content obtained in conjunction with the video content to generate a representation of the face of the user.

11. The method of claim 10, wherein the trained media generation model is applied to a frame of video content including the face of the user obtained at a time before the error was detected.

12. The method of claim 1, wherein generating, by the online system, modified video content obtained from the user by replacing at least the portion of the video content obtained from the user that includes one or more portions of the face of the user with the synthetic media comprises:
detecting one or more features of the face of the user within the obtained video content and replacing the detected one or more features with one or more corresponding features from a representation of the face of the user included in the synthetic media.

13. The method of claim 12, wherein a number of the detected one or more features of the face of the user replaced by the corresponding features from the representation of the face of the user increases as a duration of the detected error increases.

14. A computer program product comprising a non-transitory computer-readable storage medium having instructions encoded thereon that, when executed by a processor, cause the processor to:
obtain video content at an online system from a client device of a user of the online system for exchange with one or more other users of the online system, the video content including one or more portions of a face of the user;
detect an error in the video content obtained from the user audio content obtained in conjunction with the video content is desynchronized from the video content wherein detecting the error comprises comparing the video content obtained from the user with the audio content obtained from the user;
responsive to detecting the error in the video content obtained from the user, generate, by the online system, synthetic media that synchronizes with the audio content obtained in conjunction with the video content obtained from the user;
generate, by the online system, modified video content obtained from the user by replacing at least a portion of the video content obtained from the user that includes one or more portions of the face of the user with the synthetic media; and
transmit the modified video content from the online system to client devices of the one or more other users of the online system for display.

15. The computer program product of claim 14, wherein detect the error in the video content obtained from the user further comprises:
receive information describing a connection between the client device of the user and the online system from the client device; and
responsive to the information describing the connection between the client device of the user and the online system satisfying one or more conditions, detect the error in the video content obtained from the user.

16. The computer program product of claim 14, wherein detect the error in the video content obtained from the user comprises:
receive information identifying a network coupling the client device of the user and the online system;
retrieve information stored by the online system describing one or more historical characteristics of the network;
responsive to the retrieved information describing the one or more historical characteristics of the network satisfying one or more conditions, detect the error in the video content obtained from the user.

17. The computer program product of claim 14, wherein detect the error in the video content obtained from the user comprises:
compare, by the online system, positions of one or more portions of the face of the user in the obtained video content with predicted positions of the one or more portions of the face of the user determined by the online system from audio content obtained in conjunction with the video content; and
in response to at least a threshold difference between the positions of one or more portions of the face of the user in the obtained video content and the predicted positions of the one or more portions of the face of the user determined by the online system from audio content obtained in conjunction with the video content, detect the error in the video content.

18. The computer program product of claim 17, wherein compare, by the online system, the positions of one or more portions of the face of the user in the obtained video content with the predicted positions of the one or more portions of the face of the user determined by the online system from audio content obtained in conjunction with the video content comprises:
select, by the online system, a timestamp of the audio content;
generate a predicted position of the one or more portions of the face of the user at the timestamp by applying a trained model that generates positions of portions of the face of the user when different sounds are spoken to the audio content corresponding to the timestamp; and
compare the predicted position of the one or more portions of the face of the user to positions of the face of the user at a timestamp of the obtained video content corresponding to the timestamp.

19. The computer program product of claim 14, wherein generate, by the online system, synthetic media that synchronizes with audio content obtained in conjunction with the video content obtained from the user comprises:
apply a trained media generation model maintained by the online system to an identifier of the user and predicted positions of one or more portions of the face of the user corresponding to one or more times of the audio content obtained in conjunction with the video content to generate a representation of the face of the user.

20. The computer program product of claim 19, wherein the trained media generation model is applied to a frame of video content including the face of the user obtained at a time before the error was detected.

21. The computer program product of claim 14, wherein generate, by the online system, modified video content obtained from the user by replacing at least the portion of the video content obtained from the user that includes one or more portions of the face of the user with the synthetic media comprises:
detect one or more features of the face of the user within the obtained video content and replacing the detected one or more features with one or more corresponding features from a representation of the face of the user included in the synthetic media.

22. The computer program product of claim 21, wherein a number of the detected one or more features of the face of the user replaced by the corresponding features from the representation of the face of the user increases as a duration of the detected error increases.
